(19) United States
(12) Patent Application Publication
(10) Pub. No.: US 2016/0162290 A1
(43) Pub. Date: Jun. 9, 2016

(54) Processor with Polymorphic Instruction Set Architecture

(71) Applicant: INSTITUTE OF AUTOMATION, CHINESE ACADEMY OF SCIENCES, Beijing (CN)

(72) Inventors: Donglin Wang, Beijing (CN); Shaolin Xie, Beijing (CN); Yongyong Yang, Beijing (CN); Leizu Yin, Beijing (CN); Lei Wang, Beijing (CN); Zijun Liu, Beijing (CN); Tao Wang, Beijing (CN); Xing Zhang, Beijing (CN)

(21) Appl. No.: 14/785,385

(22) PCT Filed: Apr. 19, 2013
(86) PCT No.: PCT/CN2013/074426

§ 371 Date: Dec. 16, 2015

(51) Int. Cl. G06F 9/30

(52) U.S. Cl. CPC G06F 9/30

(57) ABSTRACT

The present disclosure provides a processor having polymorphic instruction set architecture. The processor comprises a scalar processing unit, at least one polymorphic instruction processing unit, at least one multi-granularity parallel memory and a DMA controller. The polymorphic instruction processing unit comprises at least one functional unit. The polymorphic instruction processing unit is configured to interpret and execute a polymorphic instruction and the functional unit is configured to perform specific data operation tasks. The scalar processing unit is configured to invoke the polymorphic instruction and inquire an execution state of the polymorphic instruction. The DMA controller is configured to transmit configuration information for the polymorphic instruction and transmit data required by the polymorphic instruction to the multi-granularity parallel memory. With the present disclosure, programmers can redefine a processor instruction set based on algorithm characteristics of applications after tape-out of a processor.

### TECHNICAL FIELD

The present disclosure generally relates to processor instruction set architecture, which is closely related to definitions of processor instruction set, processor architecture design and implementation of micro-architecture. More particularly, the present disclosure relates to a processor having polymorphic instruction set architecture that can be dynamically reconfigured after tape-out.

### BACKGROUND

Recently, Internet, Cloud Computing and Internet of Things (IoT) have been undergoing rapid growth. Ubiquitous mobile devices, RFIDs, wireless sensors are producing information every second and Internet services for billions of users are exchanging a huge amount of information. Meanwhile, users' demands on real-time characteristic and effectiveness of information processing have been increased. For example, in an online video on demand system, users require not only high definition pictures, but also decoding and displaying rates of at least 30 fps. Hence, it is desired to study how to process massive information quickly and efficiently, starting from algorithm characteristic analysis.

In general, the processing of massive information has the following characteristics. First, the amount of data is huge. The amount of data generated by high definition videos, broadband communications, high-accuracy sensors has been increasing by a factor of 5˜10 every year. Second, the amount of computation is huge. The computational complexity for information processing is typically the k-th power of the amount of data n, i.e., O(nK). For example, the bubble sorting algorithm has a computational complexity of O(n2) and the FFT algorithm has a computational complexity of O(nlogn). As the amount of data increases, the amount of computation required for information processing increases significantly. Third, the algorithms for processing massive information are relatively regular. For example, some kernel algorithms, such as one dimensional (1 D)/two dimensional (2D) filtering, FFT transformation and adaptive filtering, can be represented by simple mathematical equations, without complicated logics. Fourth, the processing of massive information has highly localized data. There is no correlation between local data blocks but there is a high correlation in each local data block. For example, in a filtering algorithm, the computation result is only dependent on data within the range of a filtering template and the data within the range of the template needs to be computed several times to obtain the final result. In a video encoding/decoding algorithm, complicated operations need to be applied to one or more (neighboring) blocks of data to obtain the final result, with no data correlation between macro blocks away from each other. Fifth, the modes of the processing algorithms remain substantially the same, while the details of the algorithms keep on evolving. For example, the video coding standard evolves from H.263 to H.264, and the communication protocol evolves from 2G to 3G and then to Long Term Evolution (LTE).

The processing of massive information has its own performance requirements and application characteristics. Since there is a huge amount of data and a huge amount of computation in the processing of massive information and most of them require real-time computation, the computational capabilities of the conventional scalar or super scalar processor are much lower than such requirements. Further, due to the limitation in power consumption and volume, it is impossible to implement a system for processing massive information simply by providing a pile of scalar processors. On the other hand, ASIC chips for processing massive information require high cost and long period to design and develop and their updates are much slower than the evolution of the processing algorithms for massive information, which cannot catch the development speed of the processing systems for massive information. Thus, it is currently a trend in processing chips for massive information to modify the conventional scalar or super scalar processor based on the characteristics of the processing of massive information, or even to design processors in a new field.

The term “instruction” refers to symbols defined by designers and understandable by processors. A programmer can specify actions of a processor at different time instants by sending to the processor different instruction sequences. A set of all instructions understandable by the processor can be referred to as an instruction set of the processor. The programmer can develop various algorithms by utilizing instructions in the instruction set.

A processor instruction set is typically defined and there is a one-to-one correspondence between instruction actions and processor implementations. For example, the ARMv4T instruction set includes a computation instruction “ADD R0, R1, R2”, which means adding the values in the registers R1 and R2 and then writing into R0.

Once the processor instruction set has been defined, the programmer cannot add instructions to the instruction set, or redefine actions for the instructions. Thus, the instructions in the processor instruction set are typically for general purpose to ensure the flexibility in programming. However, such general purpose processor instruction set cannot support some special applications efficiently. For example, in video coding, it is often required to perform 8-bit data calculations and it would be very inefficient to use e.g., the 32-bit addition instruction “ADD R0, R1, R2” in ARM processor for such calculations. Hence, various processors generally extend their instruction sets for special applications, such as MMX instructions for video image processing in the X86 instruction set and NENO instructions in the ARM instruction set.

Such extended instructions are characterized in that they are very efficient for a certain type of application, but is very inefficient for other applications. Accordingly, once the processor has been designed, its application field is decided and it is difficult for it to be applied to other application fields. Programmers cannot refine or optimize the processor based on algorithm characteristics in other application fields.

Some patents have been proposed regarding how to achieve reconfigurable computation. For example, US Patents No. US2005/0027970A1 (Reconfigurable Instruction Set Computing) and No. US2005/0169550 A1 (Video Processing System with Reconfigurable Instructions) adopt a CPU+FPGA-like structure. A user uses a uniform high-level language for development and a compiler partitions a program into a part to be executed by the CPU and a part to be executed by the FPGA. These solutions are characterized by their capabilities of increasing program efficiency by virtue of the flexibility of FPGA. However, the excessively flexible configuration of FPGA results in that the chip is not cost efficiency. US Patent No. US2004/0019765A1 (Pipelined Reconfigurable Dynamic Instruction Set Processor) provides a processor architecture of RISC processor+configurable array processor elements. In this structure, a number of array processor elements are logically divided into a number of pipeline stages and the actions of each pipeline stage is dynamically configured by the RISC processor. US Patent No. US2006/0211387 A1 (Multistandard SDR Architecture Using Context-Based

Operation Reconfigurable Instruction Set Processor) defines a processor architecture of configuration unit+co-processors, where each co-processor includes a state control unit and a data path and is responsible for some similar processor tasks.

### SUMMARY

It is an object of the present disclosure to provide a processor having polymorphic instruction set architecture, capable of solve the problem that the processor instruction set cannot be redefined after tape-out of the processor.

In order to solve the above problem, a processor having polymorphic instruction set architecture is provided. The processor comprises a scalar processing unit, at least one polymorphic instruction processing unit, at least one multi-granularity parallel memory and a DMA controller. The polymorphic instruction processing unit comprises at least one functional unit. The polymorphic instruction processing unit is configured to interpret and execute a polymorphic instruction and the functional unit is configured to perform specific data operation tasks. The polymorphic instruction is a sequence of a plurality of microcode records to be executed successively. The microcode records indicate actions to be performed by the respective functional units within a particular clock period. The scalar processing unit is configured to invoke the polymorphic instruction and inquire an execution state of the polymorphic instruction. The DMA controller is configured to transmit configuration information for the polymorphic instruction and transmit data required by the polymorphic instruction to the multi-granularity parallel memory.

In an embodiment of the present disclosure, the polymorphic instruction processing unit is configured to receive the polymorphic instruction passively from the DMA controller to be invoked by the scalar processing unit.

In an embodiment of the present disclosure, the scalar processing unit is configured to control the polymorphic instruction processing unit via a first control path and the DMA controller via a second control path.

In an embodiment of the present disclosure, the polymorphic instruction processing unit comprises: a microcode memory configured to store the polymorphic instruction; and a microcode control unit configured to receiving a control request from the scalar processing unit via the first control path and act accordingly.

In an embodiment of the present disclosure, the microcode control unit comprises a configuration register configured to store parameters required for the polymorphic instruction processing unit to operate and an operation state of the polymorphic instruction processing unit.

In an embodiment of the present disclosure, the control request from the scalar processing unit comprises activating or inquiring the polymorphic instruction processing unit and/or reading/writing the configuration register of the polymorphic instruction processing unit.

In an embodiment of the present disclosure, the polymorphic instruction processing unit further comprises a transmission control unit, wherein the functional unit has a plurality of data input/output ports and exchanges data via the transmission control unit.

In an embodiment of the present disclosure, the functional unit is configured to perform data loading/storing operations and read/write data from/to the multi-granularity parallel memory via a first internal bus, while the microcode memory is connected to the first internal bus as a slave device to receive the microcode records passively from outside.

In an embodiment of the present disclosure, the microcode control unit is configured to read and execute the microcode records of the polymorphic instruction in sequence.

In an embodiment of the present disclosure, each line in the microcode memory stores one microcode record. When the scalar processing unit invokes the polymorphic instruction, only a line number of the line in the microcode memory where a starting microcode record associated with the polymorphic instruction is lo located needs to be specified.

With the processor having the polymorphic instruction set architecture according to the present disclosure, programmers can redefine the processor instruction set based on algorithm characteristics of applications after tape-out of the processor. The redefined processor instruction set architecture is more suitable for the algorithm characteristics of the applications, so as to improve the processing performance of the processor for these applications. The redefining operation does not need to modify hardware of the processor or software tool chain including complier and linker. However, for different instruction definitions, the instruction set architecture may have different behaviors.

### BRIEF DESCRIPTION OF THE DRAWINGS

FIG. 1 briefly shows main components of a processor having polymorphic instruction set architecture and connectivity among them according to the present disclosure;

FIG. 2 briefly shows main components of a polymorphic instruction execution unit and connectivity among them according to the present disclosure;

FIG. 3 briefly shows main components of microcode records according to the present disclosure;

FIG. 4 briefly shows how to define behaviors of a polymorphic instruction and how a microcode memory stores definitions of the polymorphic instruction;

FIG. 5 shows an exemplary process for defining and invoking a polymorphic instruction according to an embodiment of the present disclosure;

FIG. 6 briefly shows functional units in a processor having polymorphic instruction set architecture according to the present disclosure;

FIG. 7 shows an exemplary interface definition and internal structure of a computing unit used in a processor according to the present disclosure;

FIG. 8 shows an exemplary interface definition and internal structure of a bus interface unit used in a processor according to the present disclosure;

FIG. 9 shows an exemplary interface definition of a register file used in a processor according to the present disclosure;

FIG. 10 shows an exemplary definition of data transmission path among functional components in a processor according to an embodiment of the present disclosure;

FIG. 11 shows an exemplary structure of data transmission units within a is computing unit in a processor according to an embodiment of the present disclosure;

FIG. 12 shows an exemplary structure of data transmission units among functional components in a processor according to an embodiment of the present disclosure;

FIG. 13 shows an exemplary coding of functional components in a processor according to an embodiment of the present disclosure; and

FIG. 14 shows exemplary logic behaviors of a multiplexer in a processor according to an embodiment of the present disclosure.

### DETAILED DESCRIPTION OF THE EMBODIMENTS

In the following, the present disclosure will be further explained with reference to the figures and specific embodiments so that the objects, solutions and advantages of the present disclosure become more apparent.

According to the present disclosure, a processor having polymorphic instruction set architecture that can be dynamically reconfigured after tape-out is provided.

FIG. 1 shows a structure of a processor according to the present disclosure, including: a scalar processing unit 101, at least one polymorphic instruction processing unit 100, at least one multi-granularity parallel memory 102 and a DMA controller 103. The polymorphic instruction processing unit 100 includes at least one functional unit 202.

A polymorphic instruction is a sequence of a plurality of microcode records to be executed successively. A polymorphic instruction set is a set of polymorphic instructions. The microcode records indicate actions to be performed by the respective functional units within a particular clock period, including e.g., addition operation, data loading operation, or no operation.

Here, the polymorphic instruction processing unit 100 is configured to interpret and execute a polymorphic instruction and the functional unit is configured to perform specific data operation tasks. The scalar processing unit 101 is configured to invoke the polymorphic instruction and inquire an execution state of the polymorphic instruction. The DMA controller 103 is configured to transmit configuration information for the polymorphic instruction and transmit data required by the polymorphic instruction to the multi-granularity parallel memory 102.

The scalar processing unit 101 is configured to control the polymorphic instruction processing unit 100 via a first control path 104 and the DMA controller 103 via a second control path 105. The DMA controller 103 transmits the configuration information to the polymorphic instruction processing unit 100 via a first internal bus 106, and transmits the data to the multi-granularity parallel memory 102 via a second internal bus 107. The DMA controller 103 reads/writes data from/to outside via a bus 108. The polymorphic instruction processing unit 100 reads/writes data from/to the multi-granularity parallel memory 102 via the second internal bus 107.

The scalar processing unit 101 can be an RISC or a DSP and has a first control path 104 for: 1) activating the polymorphic instruction processing unit 100; 2) inquiring an execution state of the polymorphic instruction processing unit 100; and 3) reading/writing a configuration register of the polymorphic instruction processing unit 100 (which will be described hereinafter).

As the multi-granularity parallel memory 102, the multi-granularity parallel memory disclosed in CN Patent Application No. 201110460585.1 (“Multi-granularity Parallel Storage System and Memory”), which can support parallel reading/writing of data from matrices of different data types in rows/columns, can be used.

The second internal bus 107 has the polymorphic instruction processing unit 100 as a master device and the multi-granularity parallel memory 102 as a slave device. The DMA controller 103 and the polymorphic instruction processing unit 100 can read/write data from/to the multi-granularity parallel memory 102 via the second internal bus 107.

The first internal bus 106 has the DMA controller 103 as a master device and the polymorphic instruction processing unit 100 as a slave device. The DMA controller 103 can write the polymorphic instruction into the polymorphic instruction processing unit 100 via the first internal but 106. The polymorphic instruction is stored in an external storage connected to the bus 108.

Polymorphic Instruction Processing Unit

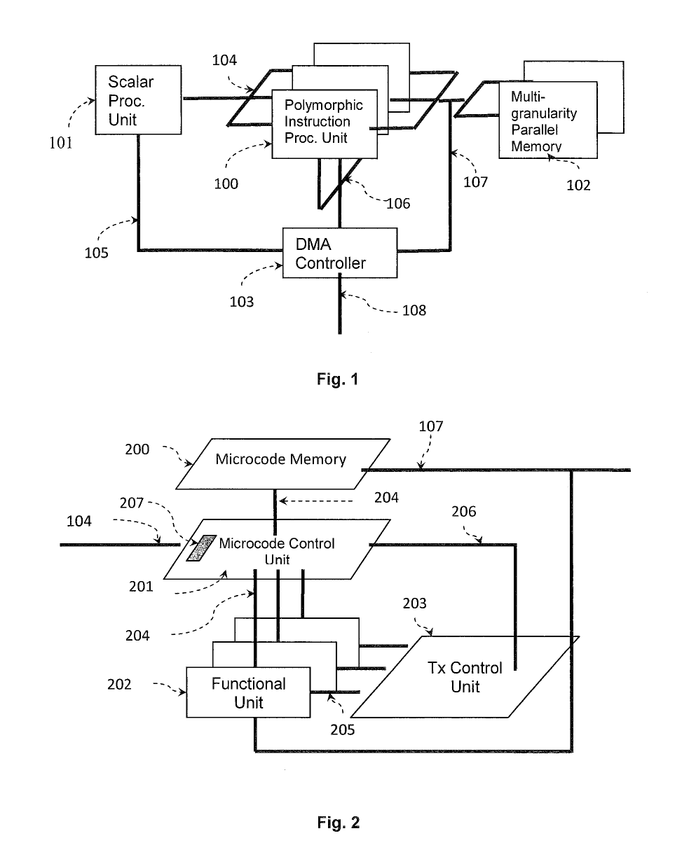

The polymorphic instruction processing unit 100 is configured to receive the polymorphic instruction passively from the DMA controller 103 to be invoked by the scalar processing unit 101. FIG. 2 shows an internal structure of the polymorphic instruction processing unit 100.

The polymorphic instruction processing unit 100 includes a microcode memory 200, a microcode control unit 201, at least one functional unit 202 and a transmission control unit 203. The microcode memory 200 is configured to store the polymorphic instruction. The microcode control unit 201 is configured to receiving a control request from the scalar processing unit 101 via the first control path 104 and act accordingly. The microcode control unit 201 includes a configuration register 207 configured to store parameters required for the polymorphic instruction processing unit 100 to operate and an operation state of the polymorphic instruction processing unit 100, e.g., to specify the functional unit 202 for executing the current polymorphic instruction, specify a starting address of the required data and the total data length, and indicate whether the polymorphic instruction processing unit 100 is currently idle or not.

The request includes requests to:

1) activate the polymorphic instruction processing unit 100: the microcode control unit 201 reads the microcode records 300 from the microcode memory 200 and generates corresponding control information for transmission to the functional unit 202 and the transmission control unit 203;

2) inquire the polymorphic instruction processing unit 100: the microcode control unit 201 returns the execution state of the current polymorphic instruction: completed or idle; and

3) read/write the configuration register 207 of the polymorphic instruction processing unit 100: the microcode control unit 201 writes specified data into the specified configuration register 207, or returns data from the specified configuration register 207.

The polymorphic instruction processing unit 100 can design at least one different function unit 202 depending on application requirements. The functional unit 202 is responsible for performing specific data operation tasks, such as addition operations or data loading/storing operations. The functional unit 202 typically has a number of data input/output ports and exchanges data via the transmission control unit 203. For example, after an adder unit has completed an addition operation, it sends the addition result to the transmission control unit 203, which then sends the addition result to a multiplier unit for multiplication.

The transmission control unit 203 is connected to the data input/output ports of all functional units 202, receives source and destination information for data at every time instant from the microcode control unit 201 via the interface 206, and sends the data from the source to the destination.

The bus 107 is the first internal bus 107 in FIG. 1. Some types of functional unit 202 need to perform data loading/storing operations and thus need to read/write data from/to the multi-granularity parallel memory 102 via the first internal bus 107. Meanwhile, the microcode memory 200 is connected to the first internal bus 107 as a slave device to receive the microcode records 300 passively from outside.

Definition and Invocation of Polymorphic Instruction

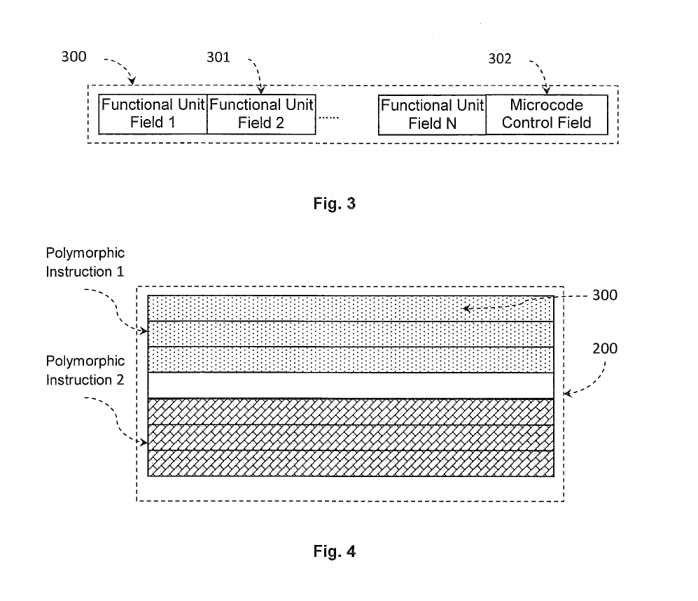

FIG. 3 shows a structure of a microcode record 300. The microcode record 300 is divided into a number of fields. Each functional unit has its corresponding field in the microcode record 300. For example, the functional unit field 301 corresponds to a second functional unit. The microcode record 300 further includes a special microcode control field 302 indicating which line of the microcode record 300 needs to be read by the microcode control unit 201 in the next clock period.

As described above, the “polymorphic instruction” as used herein refers to a sequence of microcode records 300 to be executed successively and having specific functions. As shown in FIG. 4, the polymorphic instruction, i.e., a sequence of microcode records 300, is stored in the microcode memory 200 and read and executed by the microcode control unit 201 in sequence. Each line in the microcode memory 200 stores one microcode record 300. When the scalar processing unit 101 invokes the polymorphic instruction, only a line number of the line in the microcode memory 200 where a starting microcode record associated with the polymorphic instruction is located needs to be specified.

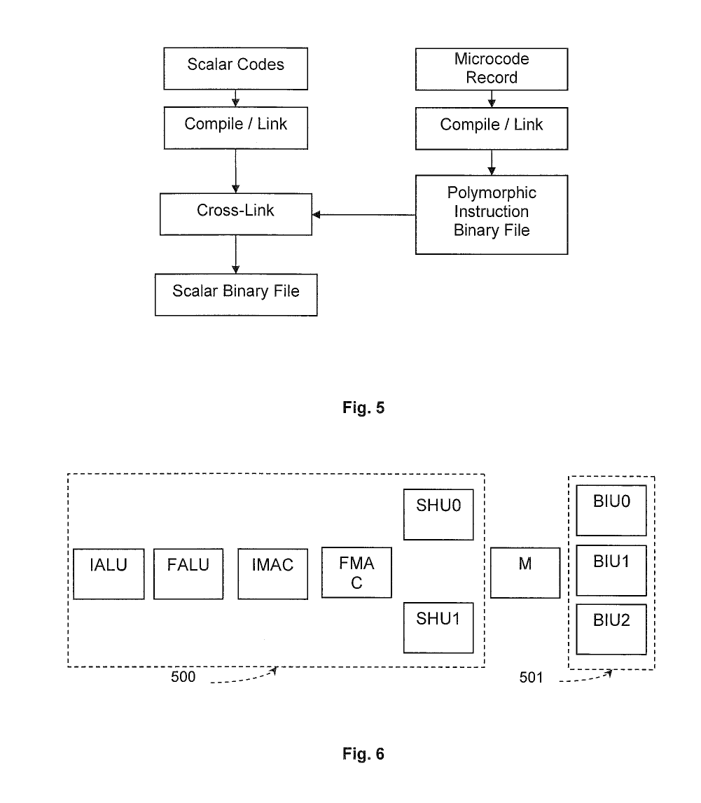

Depending on algorithm requirements, a programmer can define the behaviors of the polymorphic instruction and the starting line number of the polymorphic instruction in the microcode memory flexibly using the microcode records 300. FIG. 5 shows an exemplary process for defining and invoking the polymorphic instruction. First, the programmer defines behaviors of one or more polymorphic instructions based on application requirements and converts the behaviors of the polymorphic instruction(s) into a sequence of microcode records 300. This sequence can be expressed in text such as “ALU.T0=T1+T2 (U)∥Repeat/10)”, meaning performing 10 addition operations on ALU. Further, a scalar code is written to invoke the polymorphic instruction defined by the programmer. At this time, the starting line number of the polymorphic instruction has not been determined yet and an identifier, e.g., Instr1, is used instead. The polymorphic instruction record expressed in text is compiled and linked into a binary file interpretable by the microcode control unit 201. Meanwhile, during the compiling and linking process, the starting address for each polymorphic instruction is determined. For example, the value of Instr1 has been determined as 10 at this time. The scalar codes, which have been complied and linked, need to be cross-linked with the binary file of the polymorphic instruction to replace the starting address of the polymorphic instruction represented in symbol in the original scalar codes with an actual value , so as to generate a scalar binary file. The scalar codes use the DMA controller 103 to load the contents of the binary file for the polymorphic instruction into the microcode memory before invoking the polymorphic instruction.

Embodiment of Processor Having Polymorphic Instruction Set Architecture

In the following, an exemplary embodiment of the polymorphic instruction set architecture will be described. This embodiment is only an exemplary implementation of the present disclosure and the present disclosure is not limited thereto.

This embodiment relates to a processor having polymorphic instruction set architecture for data-intensive applications. FIG. 6 shows functional units in the processor. As shown in FIG. 6, all the functional units have a data bit width of 512 bits. In data operation, 512 bits can be treated as 64 8-bit data, or 32 16-bit data, or 16 32-bit data. Among the functional units, IALU is for fixed point logic computation, FALU is for floating point logic computation, IMAC is for fixed point multiplying and accumulating computation, FMAC is for floating point multiplying and accumulating computation, and SHU0 and SHU1 are for data interleaving operation, i.e., to swap positions of any two 8-bit data within the 512-bit data. M is a register file having a bit width of 512 bits. BIU0, BIU1 and BIU2 are bus interface units for loading/storing data from/to the multi-granularity parallel memory 102.

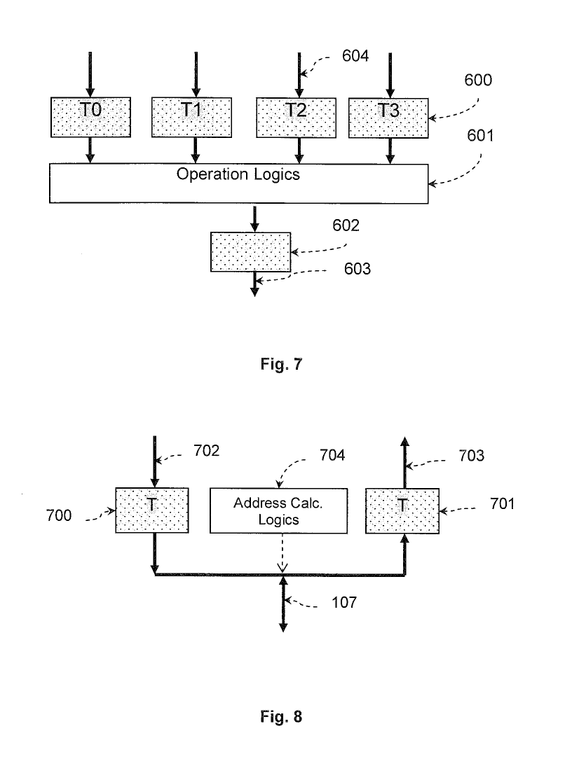

IALU, FALU, IMAC, FMAC, SHU0 and SHU1 have similar interfaces and are collectively referred to as a computing unit 500 in this embodiment. FIG. 7 shows the interfaces of the computing unit 500, including four data input/output ports 604 and four corresponding temporary registers 600. The operation logic 601 reads data from the temporary register for operation, writes the operation result into the temporary register 602, and then transmits the operation result to the transmission control unit 203 via the output port 603.

BIU0, BIU1 and BIU2 are collectively referred to as a bus interface unit 501, whose internal structure is shown in FIG. 8. It has a data input/output port 702 for obtaining data from the transmission control unit 203 and writing the obtained data into a temporary register 700; a data input/output port 703 for transmitting the data in a temporary register 701 to the transmission control unit 203; an internal bus interface 107 for reading/writing data in the multi-granularity parallel memory 102; and an address calculation logic 704 for calculating an address to be transmitted to the second internal bus 107.

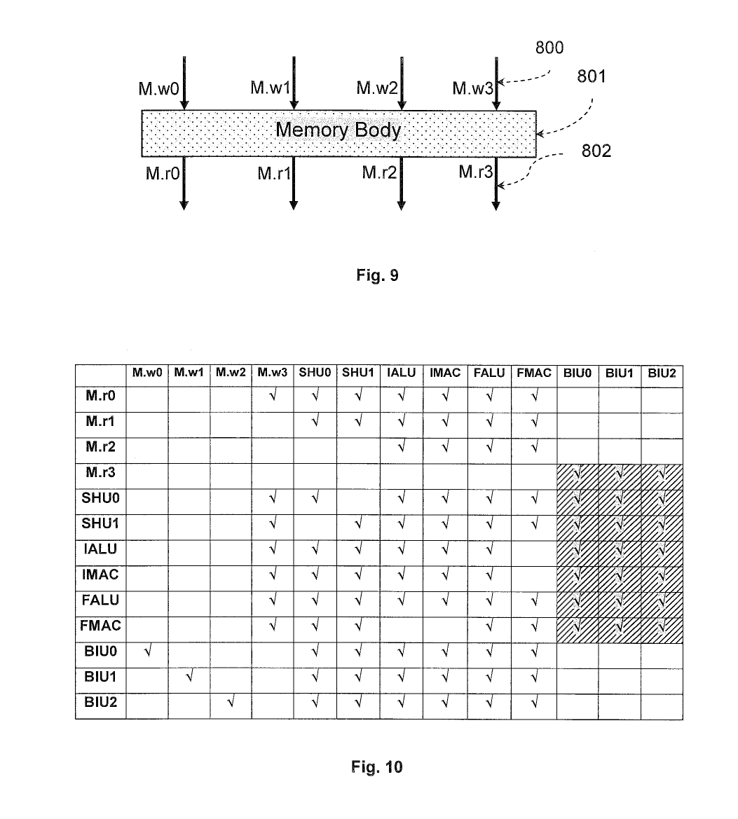

M is a register file having a bit width of 512 bits and having four writing ports 800, four reading port 802 and corresponding memory bodies 801. FIG. 9 shows interfaces of the register file.

In the polymorphic instruction set architecture, the calculation results from the respective functional units can be transmitted directly to other functional units for cascaded operations. In this embodiment, there is no need to provide a direct data transmission path between each pair of functional units. For example, FMAC mainly performs floating point multiplying and accumulating operations and its operation results do not need to be transmitted to the fixed point calculation units IALU or IMAC. The reduced number of the data transmission paths is advantageous in that the connecting lines among the functional units can be reduced, thereby reducing the chip area and the chip cost. FIG. 10 shows the data transmission paths among the functional units in this embodiment. In the table as shown in FIG. 10, the first line shows data destinations, the first column shows data sources, and each grid having a tick indicates the presence of a transmission path. Further, in order to reduce the transmission paths, some functional units may share a common transmission path depending on application requirements. The common transmission path shared between the functional units can reduce the connecting lines in the chip, but these functional units cannot transmit data simultaneously. For example, when one single transmission path is shared between transmission from SHU0 to BIU0 and transmission from SHU1 to BIU1, while data is being transmission from SHU0 to BIU0, no data can be transmitted between SHU1 and BIU1. The shadow in FIG. 10 shows transmission paths that are partially shared.

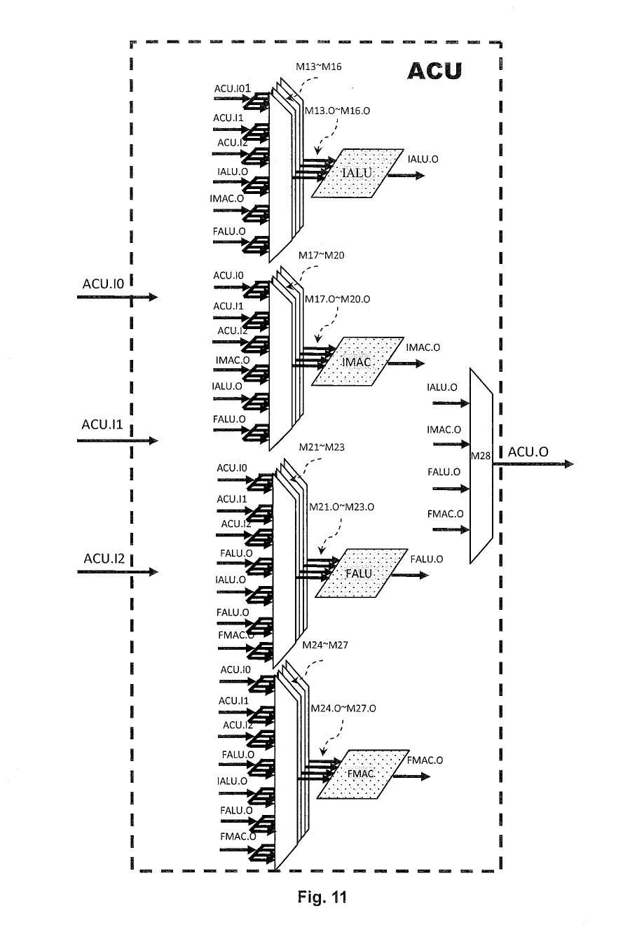

The transmission control unit 203 corresponding to FIG. 10 is composed of 29 multiplexer. For the purpose of explanation, the transmission control unit 203 is divided into two layers. The first layer is composed of IALU, IMAC FALU and FMAC and is referred to as ACU, as shown in FIG. 11. This layer communicates data with other functional units via three input ports, ACU.I0, ACU.I1 and ACU.I2, and one output port ACU.O. The ACU includes in total 16 multiplexers, i.e., M13-M28 in FIG. 11. The notations in the figure show the data inputs to the respective multiplexers.

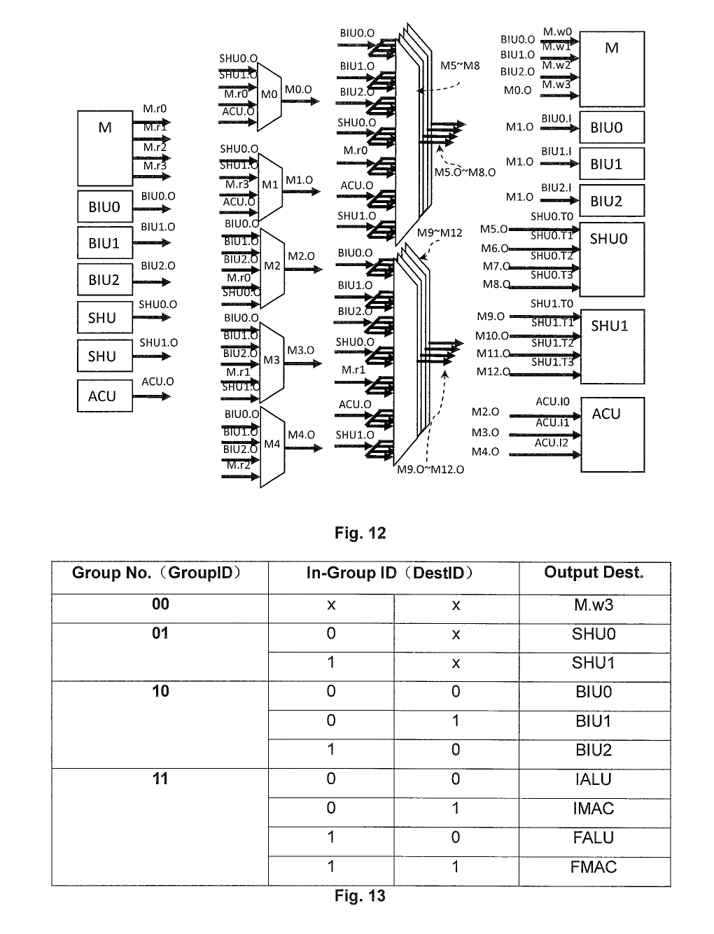

The second layer is composed of ACU, M, SHU0, SHU1 and BIU0-BIU2, as shown in FIG. 12. There are in total 13 multiplexers, i.e., M0-M12 in FIG. 12. The notations in the figure show the data inputs to the respective multiplexers.

In order to generate control signals for the 29 multiplexers in the transmission control unit 203, the functional units are first grouped and numbered. As shown in FIG. 13, “x” means unused, which could be either “0” or “1”. Each functional unit control field 301 in the microcode record 300 specifies, in addition to an operation to be performed by the functional unit, a destination of the operation result, which is specified by the code in FIG. 13. For example, an FALU control field can be expressed in text as “IALU.T0=FALU.T1+T2”, where “FALU.T1+T2” on the right side of “=” means that FALU is to perform an addition operation, and “IALU” on the left side of “=” indicates the destination of the data operation result (here the code for the destination is “1100”).

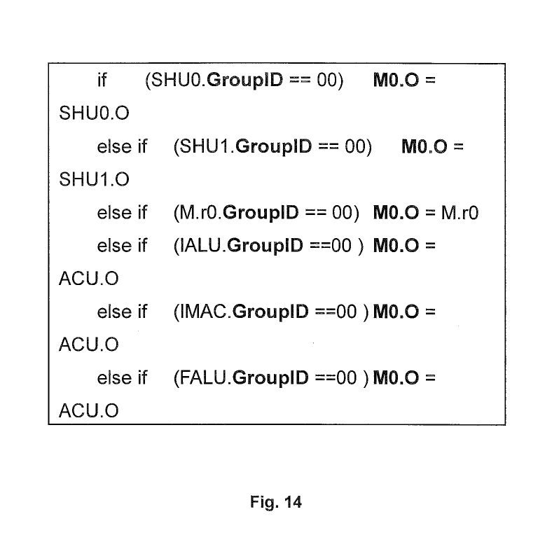

The microcode control unit 201 transmits the destination information of all the functional units in the microcode record 300 to the transmission control unit 203, which then generates the control signals for the 29 multiplexers based on the destination information. FIG. 14 shows logic behaviors of the multiplex M0, where GroupID denotes a group number of the destination in the corresponding functional unit control field 301.

The foregoing description of the embodiments illustrates the objects, solutions and advantages of the present disclosure. It will be appreciated that the foregoing description refers to specific embodiments of the present disclosure, and should not be construed as limiting the present disclosure. Any changes, substitutions, modifications and the like within the spirit and principle of the present disclosure shall fall into the scope of the present disclosure.

1. A processor having polymorphic instruction set architecture, comprising a scalar processing unit, at least one polymorphic instruction processing unit, at least one multi-granularity parallel memory and a DMA controller, the polymorphic instruction processing unit comprising at least one functional unit, wherein:
the polymorphic instruction processing unit is configured to interpret and execute a polymorphic instruction and the functional unit is configured to perform specific data operation tasks, the polymorphic instruction being a sequence of a plurality of microcode records to be executed successively, the microcode records indicating actions to be performed by the respective functional units within a particular clock period;
the scalar processing unit is configured to invoke the polymorphic instruction and inquire an execution state of the polymorphic instruction; and
the DMA controller is configured to transmit configuration information for the polymorphic instruction and transmit data required by the polymorphic instruction to the multi-granularity parallel memory.

2. The processor of claim 1, wherein the polymorphic instruction processing unit is configured to receive the polymorphic instruction passively from the DMA controller to be invoked by the scalar processing unit.

3. The processor of claim 2, wherein the scalar processing unit is configured to control the polymorphic instruction processing unit via a first control path and the DMA controller via a second control path.

4. The processor of claim 3, wherein the polymorphic instruction processing unit comprises:
a microcode memory configured to store the polymorphic instruction; and
a microcode control unit configured to receiving a control request from the scalar processing unit via the first control path and act accordingly.

5. The processor of claim 4, wherein the microcode control unit comprises a configuration register configured to store parameters required for the polymorphic instruction processing unit to operate and an operation state of the polymorphic instruction processing unit.

6. The processor of claim 5, wherein the control request from the scalar processing unit comprises activating or inquiring the polymorphic instruction processing unit and/or reading/writing the configuration register of the polymorphic instruction processing unit.

7. The processor of claim 5, wherein the polymorphic instruction processing unit further comprises a transmission control unit, wherein the functional unit has a plurality of data input/output ports and exchanges data via the transmission control unit.

8. The processor of claim 5, wherein the functional unit is configured to perform data loading/storing operations and read/write data from/to the multi-granularity parallel memory via a first internal bus, while the microcode memory is connected to the first internal bus as a slave device to receive the microcode records passively from outside.

9. The processor of claim 4, wherein the microcode control unit is configured to read and execute the microcode records of the polymorphic instruction in sequence.

10. The processor of claim 9, wherein each line in the microcode memory stores one microcode record, and, when the scalar processing unit invokes the polymorphic instruction, only a line number of the line in the microcode memory where a starting microcode record associated with the polymorphic instruction is located needs to be specified.
